(19) United States
(12) Patent Application Publication
(10) Pub. No.: US 2026/0046736 A1
(43) Pub. Date: Feb. 12, 2026

(54) CONFIGURATION OF L1 BEAM MEASUREMENT FOR LOWER LAYER MOBILITY

(71) Applicant: Nokia Technologies Oy, Espoo (FI)

(72) Inventors: Ahmad AWADA, Munich (DE); Srinivasan SELVAGANAPATHY, Bangalore (IN); Panagiotis SPAPIS, Munich (DE); Timo KOSKELA, Oulu (FI); Umur KARABULUT, Munich (DE); Alperen GUNDOGAN, Munich (DE)

(21) Appl. No.: 19/101,141

(22) PCT Filed: Jun. 14, 2023
(86) PCT No.: PCT/EP2023/065958

§ 371 Date: Feb. 4, 2025

(30) Foreign Application Priority Data
Aug. 4, 2022 (IN) 202241044593

(51) Int. Cl. H04W 36/32; H04W 36/00

(52) U.S. Cl. CPC H04W 36/324; H04W 36/0085

(57) ABSTRACT

Described herein is a first network node that supports at least one of central unit control plane (CU-CP) functionality or a layer 3 protocol of a radio access network, comprising: at least one processor; and at least one memory storing instructions that, when executed by the at least one processor, cause the first network node at least to: determine to prepare a target cell of a third network node for lower layer mobility (LLM) with a source cell of a second network node, wherein each of the second network node and the third network node supports at least one of the distributed unit (DU) functionality or a layer 2 protocol of the radio access network; obtain an association between a cell identifier of the target cell and a first identifier; and transmit a configuration message comprising information indicative of the association between the cell identifier of the target cell and the first identifier to a user equipment (UE) served by the source cell.

### TECHNOLOGY

The present disclosure relates to lower layer (L1/2) mobility, in particular to enhancements of configuration of L1 beam measurement for the lower layer mobility.

### BACKGROUND

Any discussion of the background art throughout the specification should in no way be considered as an admission that such art is widely known or forms part of common general knowledge in the field.

Broadly speaking, L1/2 inter-cell mobility is one of the upcoming objectives for mobility enhancement in the next 3rd Generation Partnership Project (3GPP) releases (e.g., release 18). In contrast to regular/conventional L3 mobility procedures where the handover between two cells is typically decided by radio resource control (RRC) layer, L1/2 inter-cell mobility is generally performed by the medium access control (MAC) layer which is typically terminated in a distributed unit (DU) of a 5G/NR (new radio) gNB.

For beam management (including the procedure of switching between beams of the same cell), the channel state information (CSI) measurement configuration (sometimes may simply be referred to as “CSI-MeasConfig”) would be provided in a higher layer (e.g., RRC) configuration information element (IE) such as a ServingCellConfig IE that is shared as an RRC container from the DU to the CU as part of an F1 (which is an interface between the CU and the DU) message such as UE Context Setup Response message. In conventional technologies, the UE may report only the L1 beam measurements for synchronization signal block (SSB) indices that have been configured by the network in the configuration of a CSI-SSB-ResourceSet. Currently, the list of SSB indices is typically limited to 64 to conform to the UE capability, i.e., UE can measure up to 64 indices simultaneously.

However, due to UE mobility, the list of the configured SSB indices may no longer be proper/valid for the lower layer inter-cell mobility, as some SSB indices that were not part of the configured CSI-SSB-ResourceSet may become more relevant. On the other hand, as can be understood by the skilled person, continuous update of CSI-SSB-ResourceSet would cause high signalling overhead over the radio and network interfaces, including:
Overhead over the radio: The update of CSI-SSB-ResourceSet would generally require the transmission of for example an RRC Reconfiguration message from the network to the UE and a corresponding RRC Reconfiguration Complete from the UE to the network.
Overhead over the network interface: In order to update the CSI-SSB-ResourceSet, the CU would generally need to coordinate the new configuration with the serving/source and target DUs over the F1 interface.

In addition to signalling overhead, the UE may also risk a mobility failure (e.g., due to a missed cell change) if the update of CSI-SSB-ResourceSet is not performed in time when the UE still has a good serving radio link.

Yet further, it may also be worthwhile to mention that, compared to some techniques (such as inter-cell beam management (ICBM)) where the UE would typically be configured with only one non-serving cell (or in other words, one target cell), in L1/2 inter-cell mobility the UE may be configured with multiple cells (e.g., up to 8 or even more prepared target cells) which makes the problem even more pronounced.

Thus, there is a need to propose new measurement related mechanisms/techniques for use in the L1/2 (lower layer) inter-cell mobility management in order to address some or all of the above-illustrated issues, particularly in an efficient, flexible yet reliable manner.

### SUMMARY

In accordance with an aspect of the present disclosure, there is provided a first network node that supports at least one of central unit control plane (CU-CP) functionality or a layer 3 (L3) protocol of a radio access network, comprising:
at least one processor; and
at least one memory storing instructions that, when executed by the at least one processor, cause the first network node at least to:
   determine to prepare a target cell of a third network node for lower layer mobility, LLM, with a source cell of a second network node, wherein each of the second network node and the third network node supports at least one of the distributed unit, DU, functionality or a layer 2 (L2) protocol of the radio access network;
   obtain an association between a cell identifier of the target cell and a first identifier; and transmit a configuration message comprising information indicative of the association between the cell identifier of the target cell and the first identifier to a user equipment, UE, served by the source cell.

In some examples, the first network node is further caused to:
transmit a message comprising information indicative of the association between the cell identifier of the target cell and the first identifier to the third network node.

In some examples, the first network node is further caused to:
receive, from the third network node, information indicative of a number of synchronization signal block (SSB) indices configured in the target cell.

In some examples, the first network node is further caused to:
transmit the information indicative of the number of SSB indices configured in the target cell to at least one of the second network node, the third network node or the UE.

In some examples, the first identifier is a cell index for distinguishing between beam measurements of different cells.

In some examples, the obtaining of the association between the cell identifier of the target cell and the first identifier comprises:
transmitting a request message comprising information indicative of the cell identifier of the target cell to the second network node; and
receiving, from the second network node, a response message comprising information indicative of the association between the cell identifier of the target cell and the cell index.

In some examples, the obtaining of the association between the cell identifier of the target cell and the first identifier comprises:
determining, by the first network node, the association between the cell identifier of the target cell and the cell index; and
the first network node is further caused to:
   transmit a request message comprising information indicative of the association between the cell identifier of the target cell and the cell index to the second network node.

In some examples, the first identifier is a configuration identifier associated with and for identifying a configuration of the prepared target cell that is used by the UE to perform a handover from the source cell.

In some examples, the obtaining of the association between the cell identifier of the target cell and the first identifier comprises:
determining, by the first network node, the association between the cell identifier of the target cell and the configuration identifier; and
the first network node is further caused to:
   transmit a request message comprising information indicative of the association between the PCI of the target cell and the configuration identifier to the second network node.

In some examples, the configuration message further comprises information indicative of a measurement related configuration.

In some examples, the measurement related configuration comprises information for configuring the UE to report N strongest beam measurements of the prepared target cell without referring to an SSB index, or a channel state information reference signal (CSI-RS) index included in the configuration message.

In some examples, the measurement related configuration comprises information for configuring the UE to decide by itself on SSB indices that the UE measures and reports.

In some examples, the cell identifier is a physical cell identifier (PCI).

In some examples, the first identifier has a bit length shorter than that of the cell identifier.

In accordance with another aspect of the present disclosure, there is provided a second network node that supports at least one of distributed unit (DU) functionality or a layer 2 (L2) protocol of a radio access network, comprising:
at least one processor; and
at least one memory storing instructions that, when executed by the at least one processor, cause the second network node at least to:
   obtain an association between a cell identifier of a target cell of a third network node that supports at least one of the DU functionality or the layer 2 protocol of the radio access network, and a first identifier, wherein the target cell is prepared for lower layer mobility, LLM, with a source cell of the second network node by a first network that supports at least one of central unit control plane (CU-CP) functionality or a layer 3 (L3) protocol of the radio access network; and
   receive, from a user equipment (UE) served by the source cell, a message comprising information indicative of a measurement report related to at least one beam of the target cell, and the first identifier.

In some examples, the second network node is further caused to receive, from the first network node, information indicative of a number of synchronization signal block, SSB, indices configured in the prepared target cell.

In some examples, the first identifier is a cell index for distinguishing between beam measurements of different cells.

In some examples, the obtaining of the association between the cell identifier of the target cell and the first identifier comprises:
receiving, from the first network node, a request message comprising information indicative of the cell identifier of the target cell; and
determining, by the second network node, the association between the cell identifier of the target and the cell index; and
the second network node is further caused to:
transmit a response message comprising information indicative of the association between the PCI of the target and the cell index to the first network node.

In some examples, the obtaining of the association between the cell identifier of the target cell and the first identifier comprises:
receiving, from the first network node, a message comprising information indicative of the association between the cell identifier of the target cell and the cell index.

In some examples, the first identifier is a configuration identifier associated with and for identifying a configuration of the target cell sent by the first network node to configure the UE for handover to the target cell; and
the obtaining of the association between the cell identifier of the target cell and the first identifier comprises:
receiving, from the first network node, a message comprising information indicative of the association between the cell identifier of the target cell and the configuration identifier.

In some examples, the second network node is further caused to:
generate a measurement related configuration comprising information for configuring the UE to report N strongest beam measurements of the prepared target cell without referring to an SSB index, or a channel state information reference signal (CSI-RS) index included in the measurement related configuration; and
transmit a message comprising information indicative of the measurement related configuration to the first network node.

In some examples, the second network node is further caused to:
generate a measurement related configuration comprising information for configuring the UE to decide by itself on SSB indices that the UE measures and reports; and
transmit a message comprising information indicative of the measurement related configuration to the first network node.

In some examples, the message received from the UE further comprises information indicative of an index of an SSB detected by the UE for the measurement of at least one beam of the target cell.

In some examples, the second network node is further caused to transmit a message comprising information indicative of an instruction for the UE to switch from the source cell to the target cell.

In some examples, the cell identifier is a physical cell identifier (PCI).

In some examples, the first identifier has a bit length shorter than that of the cell identifier.

In accordance with yet another aspect of the present disclosure, there is provided a user equipment (UE) served by a source cell of a second network node that supports at least one of distributed unit (DU) functionality or a layer 2 (L2) protocol of a radio access network, the UE comprising:
at least one processor; and
at least one memory storing instructions that, when executed by the at least one processor, cause the UE at least to:
   obtain an association between a cell identifier of a target cell of a third network node that supports at least one of the DU functionality or the layer 2 protocol of the radio access network, and a first identifier; and
   transmit a message comprising information indicative of a measurement report related to at least one beam of the target cell, and the first identifier to the second network node.

In some examples, the first identifier is a cell index for distinguishing between beam measurements of different cells, and the obtaining of the association between the cell identifier of the target cell and the first identifier comprises:
receiving, from a first network node that supports at least one of central unit control plane, CU-CP, functionality or a layer 3 protocol of the radio access network, a configuration message comprising information indicative of the association between the cell identifier of the target cell and the cell index.

In some examples, the received configuration message is a RRC Reconfiguration message further comprising CSI measurement related configurations suitable for supporting L1/2 mobility functionality and a number of SSB indices configured in the target cell, and the transmitted message is a L1 measurement report comprising the cell index, an SSB index, and information on L1-RSRP.

In some examples, the first identifier is a configuration identifier associated with and for identifying a configuration of the target cell for handover by the UE, and the obtaining of the association between the cell identifier of the target cell and the first identifier comprises:
receiving, from a first network node that supports at least one of central unit control plane, CU-CP, functionality or a layer 3 protocol of the radio access network, a configuration message comprising information indicative of the association between the cell identifier of the target cell and the cell index.

In some examples, the received configuration message is a RRC Reconfiguration message further comprising CSI measurement related configurations suitable for supporting L1/2 mobility functionality and a number of SSB indices configured in the target cell, and the transmitted message is a L1 measurement report comprising the configuration identifier, an SSB index, and information on L1-RSRP.

In some examples, the configuration message further comprises information indicative of a measurement related configuration comprising information for configuring the UE, without referring to a synchronization signal block (SSB) index, or a channel state information reference signal (CSI-RS) index included in the configuration message, to report N strongest beam measurements of the target cell.

In some examples, the configuration message further comprises information indicative of a measurement related configuration comprising information for configuring the UE to decide by itself on synchronization signal block (SSB) indices that the UE measures and reports.

In some examples, the transmitting a message comprises transmitting a message comprising information indicative of a measurement report relating to the strongest beam measurements of the target cell.

In some examples, the configuration message further comprises information indicative of a number of SSB indices configured in the target cell.

In some examples, the message transmitted to the second network node further comprises information indicative of an index of an SSB detected by the UE for the measurement.

In some examples, the UE is further caused to:
receive, from the second network node, a message comprising information indicative of an instruction for the UE to switch from the source cell to the target cell.

In some examples, the cell identifier is a physical cell identifier (PCI).

In some examples, the first identifier has a bit length shorter than that of the cell identifier.

In accordance with yet another aspect of the present disclosure, there is provided a method of a first network node that supports at least one of central unit control plane (CU-CP) functionality or a layer 3 (L3) protocol of a radio access network, the method comprising:
determining to prepare a target cell of a third network node for lower layer mobility (LLM) with a source cell of a second network node, wherein each of the second network node and the third network node supports at least one of the distributed unit (DU) functionality or a layer 2 protocol of the radio access network;
obtaining an association between a cell identifier of the target cell and a first identifier; and
transmitting a configuration message comprising information indicative of the association between the cell identifier of the target cell and the first identification to a user equipment (UE) served by the source cell.

In accordance with yet another aspect of the present disclosure, there is provided a method of a second network node that supports at least one of distributed unit (DU) functionality or a layer 2 (L2) protocol of a radio access network, the method comprising:
obtaining an association between a cell identifier of a target cell of a third network node that supports at least one of the DU functionality or the layer 2 (L2) protocol of the radio access network, and a first identifier, wherein the target cell is prepared for lower layer mobility, LLM, with a source cell of the second network node by a first network that supports at least one of central unit control plane (CU-CP) functionality or a layer 3 (L3) protocol of the radio access network; and
receiving, from a user equipment (UE) served by the source cell, a message comprising information indicative of a measurement report related to at least one beam of the target cell, and the first identifier.

In accordance with yet another aspect of the present disclosure, there is provided a method of a user equipment (UE) served by a source cell of a second network node that supports at least one of distributed unit (DU) functionality or a layer 2 (L2) protocol of a radio access network, the method comprising:
obtain an association between a cell identifier of a target cell of a third network node that supports at least one of the DU functionality or the layer 2 (L2) protocol of the radio access network, and a first identifier; and
transmit a message comprising information indicative of a measurement report related to at least one beam of the target cell, and the first identifier to the second network node.

According to some example embodiments, there is also provided a computer program comprising instructions for causing an apparatus to perform the method as disclosed in the present disclosure.

According to some example embodiments, there is also provided a memory storing computer readable instructions for causing an apparatus to perform the method as disclosed in the present disclosure

Furthermore, according to some example embodiments, there is provided a first network node that supports at least one of central unit control plane (CU-CP) functionality or a layer 3 (L3) protocol of a radio access network, comprising respective suitable means configured for performing the respective steps as disclosed in the present disclosure.

Similarly, according to some example embodiments, there is also provided a second network node and a third network node that support at least one of distributed unit (DU) functionality or a layer 2 (L2) protocol of a radio access network, comprising respective suitable means configured for performing the respective steps as disclosed in the present disclosure.

In addition, according to some other example embodiments, there is provided, for example, a computer program product for a wireless communication device comprising at least one processor, including software code portions for performing the respective steps disclosed in the present disclosure, when said product is run on the device. The computer program product may include a computer-readable medium on which said software code portions are stored. Furthermore, the computer program product may be directly loadable into the internal memory of the computer and/or transmittable via a network by means of at least one of upload, download and push procedures.

While some example embodiments will be described herein with particular reference to the above application, it will be appreciated that the present disclosure is not limited to such a field of use, and is applicable in broader contexts.

Notably, it is understood that methods according to the present disclosure relate to methods of operating the apparatuses according to the above example embodiments and variations thereof, and that respective statements made with regard to the apparatuses likewise apply to the corresponding methods, and vice versa, such that similar description may be omitted for the sake of conciseness. In addition, the above aspects may be combined in many ways, even if not explicitly disclosed. The skilled person will understand that these combinations of aspects and features/steps are possible unless it creates a contradiction which is explicitly excluded.

Implementations of the disclosed apparatuses may include using, but not limited to, one or more processor, one or more application specific integrated circuit (ASIC) and/or one or more field programmable gate array (FPGA). Implementations of the apparatus may also include using other conventional and/or customized hardware such as software programmable processors, such as graphics processing unit (GPU) processors.

Other and further example embodiments of the present disclosure will become apparent during the course of the following discussion and by reference to the accompanying drawings.

### BRIEF DESCRIPTION OF THE DRAWINGS

Example embodiments of the disclosure will now be described, by way of example only, with reference to the accompanying drawings in which:

FIG. 1 schematically illustrates an example of a signaling/messaging flowchart according to example embodiments of the present disclosure;

FIG. 2 schematically illustrates an example of a channel state information (CSI) measurement configuration according to example embodiments of the present disclosure;

FIG. 3 schematically illustrates examples of CSI measurement related configurations according to example embodiments of the present disclosure;

FIG. 4 schematically illustrates another example of a signaling/messaging flowchart according to example embodiments of the present disclosure;

FIG. 5 schematically illustrates another example of a signaling/messaging flowchart according to another example embodiment of the present disclosure; and

FIG. 6 schematically illustrates yet an example of a signaling/messaging flowchart according to yet another example embodiment of the present disclosure.

### DESCRIPTION OF EXAMPLE EMBODIMENTS

In the following, different exemplifying embodiments will be described using, as an example of a communication network to which examples of embodiments may be applied, a communication network architecture based on 3GPP standards for a communication network, such as a 5G/NR, without restricting the embodiments to such an architecture, however. It is apparent for a person skilled in the art that the embodiments may also be applied to other kinds of communication networks where mobile communication principles are integrated with a D2D (device-to-device) or V2X (vehicle to everything) configuration, such as SL (side link), e.g. Wi-Fi, worldwide interoperability for microwave access (WiMAX), Bluetooth®, personal communications services (PCS), ZigBee®, wideband code division multiple access (WCDMA), systems using ultra-wideband (UWB) technology, mobile ad-hoc networks (MANETs), wired access, etc. Furthermore, without loss of generality, the description of some examples of embodiments is related to a mobile communication network, but principles of the disclosure can be extended and applied to any other type of communication network, such as a wired communication network.

The following examples and embodiments are to be understood only as illustrative examples. Although the specification may refer to “an”, “one”, or “some” example(s) or embodiment(s) in several locations, this does not necessarily mean that each such reference is related to the same example(s) or embodiment(s), or that the feature only applies to a single example or embodiment. Single features of different embodiments may also be combined to provide other embodiments. Furthermore, terms like “comprising” and “including” should be understood as not limiting the described embodiments to consist of only those features that have been mentioned; such examples and embodiments may also contain features, structures, units, modules, etc., that have not been specifically mentioned.

A basic system architecture of a (tele) communication network including a mobile communication system where some examples of embodiments are applicable may include an architecture of one or more communication networks including wireless access network subsystem(s) and core network(s). Such an architecture may include one or more communication network control elements or functions, access network elements, radio access network elements, access service network gateways or base transceiver stations, such as a base station (BS), an access point (AP), a NodeB (NB), an eNB or a gNB, a distributed unit (DU) or a centralized/central unit (CU), which controls a respective coverage area or cell(s) and with which one or more communication stations such as communication elements or functions, like user devices or terminal devices, like a user equipment (UE), or another device having a similar function, such as a modem chipset, a chip, a module etc., which can also be part of a station, an element, a function or an application capable of conducting a communication, such as a UE, an element or function usable in a machine-to-machine communication architecture, or attached as a separate element to such an element, function or application capable of conducting a communication, or the like, are capable to communicate via one or more channels via one or more communication beams for transmitting several types of data in a plurality of access domains. Furthermore, core network elements or network functions, such as gateway network elements/functions, mobility management entities, a mobile switching center, servers, databases and the like may be included.

The following description may provide further details of alternatives, modifications and variances: a gNB comprises e.g., a node providing NR user plane and control plane protocol terminations towards the UE, and connected via the NG interface to the 5GC, e.g., according to 3GPP TS 38.300 V16.6.0 (2021-06) section 3.2 incorporated by reference.

A gNB Central Unit (gNB-CU) comprises e.g., a logical node hosting e.g., RRC, SDAP and PDCP protocols of the gNB or RRC and PDCP protocols of the en-gNB that controls the operation of one or more gNB-DUs. The gNB-CU terminates the F1 interface connected with the gNB-DU.

A gNB Distributed Unit (gNB-DU) comprises e.g., a logical node hosting e.g., RLC, MAC and PHY layers of the gNB or en-gNB, and its operation is partly controlled by the gNB-CU. One gNB-DU supports one or multiple cells. One cell is supported by only one gNB-DU. The gNB-DU terminates the F1 interface connected with the gNB-CU.

A gNB-CU-Control Plane (gNB-CU-CP) comprises e.g., a logical node hosting e.g., the RRC and the control plane part of the PDCP protocol of the gNB-CU for an en-gNB or a gNB. The gNB-CU-CP terminates the E1 interface connected with the gNB-CU-UP and the F1-C interface connected with the gNB-DU.

A gNB-CU-User Plane (gNB-CU-UP) comprises e.g., a logical node hosting e.g., the user plane part of the PDCP protocol of the gNB-CU for an en-gNB, and the user plane part of the PDCP protocol and the SDAP protocol of the gNB-CU for a gNB. The gNB-CU-UP terminates the E1 interface connected with the gNB-CU-CP and the F1-U interface connected with the gNB-DU, e.g., according to 3GPP TS 38.401 V16.6.0 (2021-07) section 3.1 incorporated by reference.

Different functional splits between the central and distributed unit are possible, e.g., called options:
Option 1 (1A-like split):
   The function split in this option is similar to the 1A architecture in DC. RRC is in the central unit. PDCP, RLC, MAC, physical layer and RF are in the distributed unit.
Option 2 (3C-like split):
   The function split in this option is similar to the 3C architecture in DC. RRC and PDCP are in the central unit. RLC, MAC, physical layer and RF are in the distributed unit.
Option 3 (intra RLC split):
   Low RLC (partial function of RLC), MAC, physical layer and RF are in the distributed unit. PDCP and high RLC (the other partial function of RLC) are in the central unit.
Option 4 (RLC-MAC split):
   MAC, physical layer and RF are in the distributed unit. PDCP and RLC are in the central unit.
Or else, e.g., according to 3GPP TR 38.801 V14.0.0 (2017-03) section 11 incorporated by reference.

A gNB supports different protocol layers, e.g., Layer 1 (L1)-physical layer.

The layer 2 (L2) of NR is split into the following sublayers: Medium Access Control (MAC), Radio Link Control (RLC), Packet Data Convergence Protocol (PDCP) and Service Data Adaptation Protocol (SDAP), where e.g.:
The physical layer offers to the MAC sublayer transport channels;
The MAC sublayer offers to the RLC sublayer logical channels;
The RLC sublayer offers to the PDCP sublayer RLC channels;
The PDCP sublayer offers to the SDAP sublayer radio bearers;
The SDAP sublayer offers to 5GC QoS flows;
Comp. refers to header compression and Segm. To segmentation;
Control channels include (BCCH, PCCH).

Layer 3 (L3) includes e.g., Radio Resource Control (RRC), e.g., according to 3GPP TS 38.300 V16.6.0 (2021-06) section 6 incorporated by reference.

A RAN (Radio Access Network) node or network node like e.g. a gNB, base station, gNB CU or gNB DU or parts thereof may be implemented using e.g. an apparatus with at least one processor and/or at least one memory (with computer-readable instructions (computer program)) configured to support and/or provision and/or process CU and/or DU related functionality and/or features, and/or at least one protocol (sub-) layer of a RAN (Radio Access Network), e.g. layer 2 and/or layer 3.

The gNB CU and gNB DU parts may e.g., be co-located or physically separated. The gNB DU may even be split further, e.g., into two parts, e.g., one including processing equipment and one including an antenna. A Central Unit (CU) may also be called BBU/REC/RCC/C-RAN/V-RAN, O-RAN, or part thereof. A Distributed Unit (DU) may also be called RRH/RRU/RE/RU, or part thereof. Hereinafter, in various example embodiments of the present disclosure, the CU-CP (or more generically, the CU) may also be referred to as a (first) network node that supports at least one of central unit control plane functionality or a layer 3 protocol of a radio access network; and similarly, the DU may be referred to as a (second) network node that supports at least one of distributed unit functionality or the layer 2 protocol of the radio access network.

A gNB-DU supports one or multiple cells, and could thus serve as e.g., a serving cell for a user equipment (UE).

A user equipment (UE) may include a wireless or mobile device, an apparatus with a radio interface to interact with a RAN (Radio Access Network), a smartphone, an in-vehicle apparatus, an IoT device, a M2M device, or else. Such UE or apparatus may comprise: at least one processor; and at least one memory including computer program code; wherein the at least one memory and the computer program code are configured to, with the at least one processor, cause the apparatus at least to perform certain operations, like e.g. RRC connection to the RAN. A UE is e.g., configured to generate a message (e.g., including a cell ID) to be transmitted via radio towards a RAN (e.g., to reach and communicate with a serving cell). A UE may generate and transmit and receive RRC messages containing one or more RRC PDUs (Packet Data Units).

The UE may have different states (e.g., according to 3GPP TS 38.331 V16.5.0 (2021-06) sections 42.1 and 4.4, incorporated by reference).

A UE is e.g., either in RRC_CONNECTED state or in RRC_INACTIVE state when an RRC connection has been established.

In RRC_CONNECTED state a UE may:
store the AS context;
transfer unicast data to/from the UE;
monitor control channels associated with the shared data channel to determine if data is scheduled for the data channel;
provide channel quality and feedback information;
perform neighboring cell measurements and measurement reporting.

The RRC protocol includes e.g. the following main functions:
RRC connection control;
measurement configuration and reporting;
establishment/modification/release of measurement configuration (e.g. intra-frequency, inter-frequency and inter-RAT measurements);
setup and release of measurement gaps;
measurement reporting.

The general functions and interconnections of the described elements and functions, which also depend on the actual network type, are known to those skilled in the art and described in corresponding specifications, so that a detailed description thereof may omitted herein for the sake of conciseness. However, it is to be noted that several additional network elements and signaling links may be employed for a communication to or from an element, function or application, like a communication endpoint, a communication network control element, such as a server, a gateway, a radio network controller, and other elements of the same or other communication networks besides those described in detail herein below.

A communication network architecture as being considered in examples of embodiments may also be able to communicate with other networks, such as a public switched telephone network or the Internet. The communication network may also be able to support the usage of cloud services for virtual network elements or functions thereof, wherein it is to be noted that the virtual network part of the telecommunication network can also be provided by non-cloud resources, e.g. an internal network or the like. It should be appreciated that network elements of an access system, of a core network etc., and/or respective functionalities may be implemented by using any node, host, server, access node or entity etc. being suitable for such a usage. Generally, a network function can be implemented either as a network element on a dedicated hardware, as a software instance running on a dedicated hardware, or as a virtualized function instantiated on an appropriate platform, e.g., a cloud infrastructure.

Furthermore, a network element, such as communication elements, like a UE, a terminal device, control elements or functions, such as access network elements, like a base station/BS, a gNB, a radio network controller, a core network control element or function, such as a gateway element, or other network elements or functions, as described herein, and any other elements, functions or applications may be implemented by software, e.g., by a computer program product for a computer, and/or by hardware. For executing their respective processing, correspondingly used devices, nodes, functions or network elements may include several means, modules, units, components, etc. (not shown) which are required for control, processing and/or communication/signaling functionality. Such means, modules, units and components may include, for example, one or more processors or processor units including one or more processing portions for executing instructions and/or programs and/or for processing data, storage or memory units or means for storing instructions, programs and/or data, for serving as a work area of the processor or processing portion and the like (e.g. ROM, RAM, EEPROM, and the like), input or interface means for inputting data and instructions by software (e.g. floppy disc, CD-ROM, EEPROM, and the like), a user interface for providing monitor and manipulation possibilities to a user (e.g. a screen, a keyboard and the like), other interface or means for establishing links and/or connections under the control of the processor unit or portion (e.g. wired and wireless interface means, radio interface means including e.g. an antenna unit or the like, means for forming a radio communication part etc.) and the like, wherein respective means forming an interface, such as a radio communication part, can be also located on a remote site (e.g. a radio head or a radio station etc.). It is to be noted that in the present specification processing portions should not be only considered to represent physical portions of one or more processors, but may also be considered as a logical division of the referred processing tasks performed by one or more processors. It should be appreciated that according to some examples, a so-called “liquid” or flexible network concept may be employed where the operations and functionalities of a network element, a network function, or of another entity of the network, may be performed in different entities or functions, such as in a node, host or server, in a flexible manner. In other words, a “division of labor” between involved network elements, functions or entities may vary case by case.

As illustrated above, techniques related to L1/2 inter-cell mobility (or sometimes also referred to as lower layer mobility, LLM) is one of the upcoming objectives for mobility enhancement under consideration for example in Release 18 of the 3rd Generation Partnership Project (3GPP). In contrast to (conventional) L3 mobility procedures where the handover procedure between two cells is typically decided by the RRC layer, the L1/2 inter-cell mobility is generally performed by the MAC layer that is normally terminated in a DU of a 5G/NR gNB.

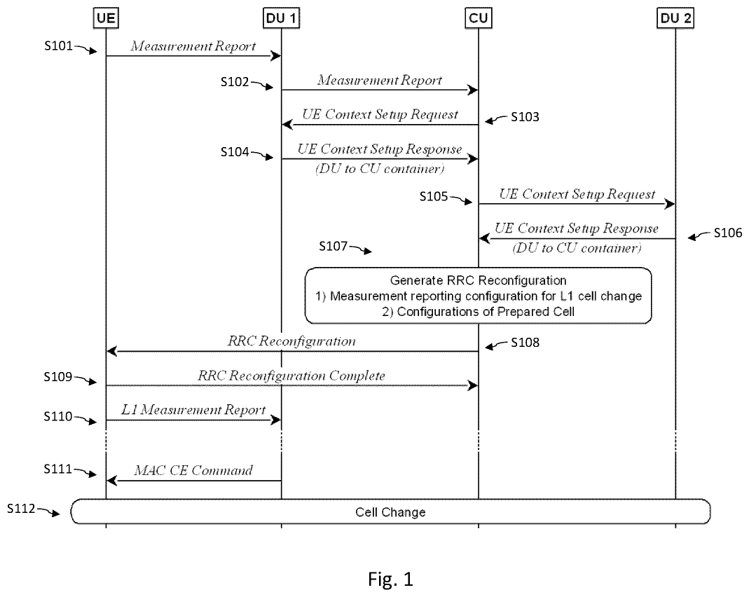

FIG. 1 schematically shows one exemplary implementation for a signalling diagram of the L1/2 inter-cell mobility from a serving/source cell in DU 1 (sometimes may also be referred to as a source/serving DU) to a target cell in DU 2 (sometimes may also be referred to as a target DU), which may also be considered as an inter-DU intra-CU scenario. The same diagram might also apply (with possible adaptation, if necessary) in the case of an intra-DU intra-CU cell change/switch, where DU 1 would be the same as DU 2. In such a case, the DU 1 (or DU 2) might itself be referred to as both the source/serving and also the target cell.

In particular, the main steps of such a L1/2 inter-cell mobility procedure could be summarized as follows.

In step S101, the UE may send a measurement report containing for example the cell quality measurements of the serving/source and also the neighbouring cell(s). In some possible cases, the UE could be configured by the serving cell to send measurement reports early when it still has a good connection to the serving cell. This measurement report is received by DU 1 (source/serving DU) and then further propagated to the CU (as exemplified in step S102).

Using the reported cell quality measurements, the CU may identify a potential set of candidate target cells (from the overall neighbouring cells, controlled by the same or different DU(s)) to which the UE can be handed over to. In this example as shown in FIG. 1, the CU identifies candidate target cells that are served by DU 1 (controlling the serving DU/cell) and by another DU 2 that is controlled by the same CU.

In step S103, the CU may request the preparation of a candidate target cell controlled by DU 1 for example by sending a UE Context Setup Request message (or any other suitable message).

In step S104, DU 1 may provide the configuration of the UE in a corresponding UE Context Setup Response message (or any other suitable message) containing a message container from DU to CU.

Similarly, steps S105 and S106 could also be performed with DU 2 in order to prepare the target cell(s) that are controlled by DU 2.

Having received the UE configurations for the candidate target cell(s) (as exemplified in steps S104 and S106), the CU may generate, in step S107, an RRC Reconfiguration message (or the like) that would be sent to the UE in step S108. Among other possible/suitable information, the RRC Reconfiguration message may contain:
measurement reporting configuration for L1/2 handover/mobility, e.g., configuration(s) on how to report the L1 beam measurements of the serving and target cells in step S110; and
configuration(s) of the prepared candidate cell(s) which the UE needs to execute when it receives for example a MAC CE command to change/switch the serving cell (i.e., to perform the handover) as shown in step S111.

After confirming the RRC Reconfiguration to the network in step S109 (e.g., by sending a corresponding RRC Reconfiguration Complete message or the like), the UE may now start to report (e.g., periodically, etc.) the L1 beam measurement(s) of the serving and of the candidate target cells as shown in step S110.

Upon determining that there is a target candidate cell having a better radio link/beam measurement than that of the serving cell (e.g., based on the determination that the L1-RSRP (reference signal received power) of the target beam measurement is larger than the L1-RSRP of serving beam measurement possibly plus an offset for an amount of time, e.g., Time-to-Trigger (TTT), or based on any other suitable criteria), the serving cell may send a MAC Control Element (MAC CE) or a suitable L1 message in step S111 to trigger the cell change/switch to the target candidate cell. In some possible cases, the MAC CE may for example comprise a transmission configuration indication (TCI) state change information indicative of the beam of the target candidate cell, or any other suitable information.

As a result of such a MAC CE or a suitable L1 message, the (lower layer) handover from the serving cell to the target cell is executed by the UE in step S112.

For beam management (including the procedure of switching between beams of the same cell), the channel state information (CSI) measurement configuration (sometimes may simply be referred to as “CSI-MeasConfig”) would be provided in a higher layer (e.g., RRC) configuration information element (IE) such as a ServingCellConfig IE that is shared as an RRC container from the DU to the CU (e.g., as illustrated with reference to steps S104 and S106 of FIG. 1) as part of an F1 (which is generally an interface between the CU and the DU) message such as UE Context Setup Response message.

Generally speaking, a CSI-MeasConfig may be understood to contain the CSI measurement related configuration that may comprise, among other possibilities:
CSI reporting related configuration(s) containing for example information on how the UE shall report the L1 beam measurements; and
CSI resource related configuration(s) containing for example information for which reference signal (RS), such as synchronization signal block (SSB) or CSI-RS, the UE needs to report the beam measurements.

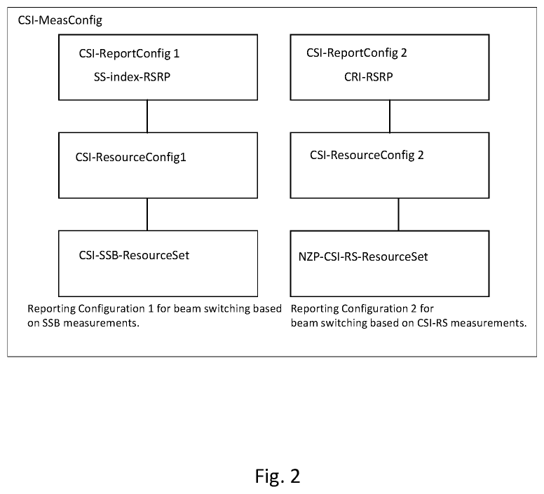

In the example as shown in FIG. 2, the exemplary CSI-MeasConfig may be seen to contain two CSI reporting configurations that are associated with different RSs: SSB (on the left side) and CSI-RS (on the right side).

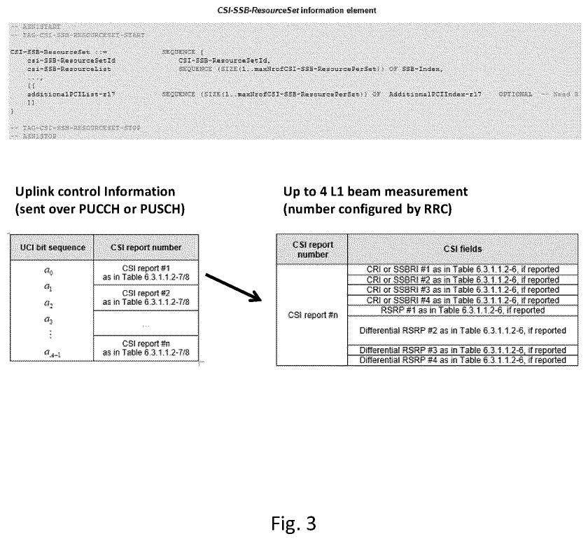

In release 17 of the 3GPP, the CSI measurement related configuration has been extended such that the UE may be enabled to report the L1 beam measurements for non-serving cell(s), in order to possibly better support for inter-cell beam management (ICBM) allowing the UE to be served by a (“borrowed”) beam from another cell. As a result of such extension, the CSI-SSB-ResourceSet may also be extended to contain, in addition to the configuration of SSB indices that the UE shall measure and use for reporting the L1 beam measurements, also possibly the physical cell identifier (PCI) associated with each configured SSB index. An illustrative example for such a possible (extended) configuration is shown in FIG. 3 (upper diagram).

As can be understood and appreciated by the skilled person, the L1 beam measurements are typically provided by the UE to the network (e.g., the DU, or the CU via the DU) in a CSI-Report (or any other suitable form/message) which is typically a part of uplink control information (UCI) that is sent either over physical uplink common control channel (PUCCH) or physical uplink shared channel (PUSCH). An illustrative example for such a possible UCI is schematically shown in FIG. 3, lower left diagram.

In a broad sense, as it is also schematically shown in the lower right diagram of FIG. 3, in some possible (non-limiting) examples, the CSI report may comprise the following elements (as schematically shown in the lower right diagram of FIG. 3):
Channel State Information-Reference Signal Resource Indicator (CRI) or SS/PBCH Block Resource Indicator (SSB-RI). In general, the length of the SSB-RI may depend on the number of SSB indices that are configured in the CSI-SSB-ResourceSet (as schematically shown in the upper diagram of FIG. 3). As a simple illustrative example, if a total of 64 SSB indices are defined, the length of the SSB-RI would then be 6 bits.
RSRP of each CRI or SSB-RI. In some possible (non-limiting) implementations, the length of the RSRP for the first reported CRI or SSB-RI may be 7 bits whereas the length of different RSRP for the remaining e.g., three indices (if reported) is 4 bits.

In conventional technologies, the UE may report only the L1 beam measurements for synchronization signal block (SSB) indices that have been configured by the network in the configuration of CSI-SSB-ResourceSet. Currently, the list of SSB indices is typically limited to 64 to conform to the UE capability. In other words, UE could in theory measure up to 64 indices simultaneously. Moreover, the maximum number N of L1 beam measurements to be reported is configured by the network. In the example of FIG. 3, N is equal to 4 and is much smaller than the number of SSB indices that are configured in CSI-SSB-ResourceSet.

However, due to UE mobility, the list of the configured SSB indices may no longer be proper/valid for the lower layer inter-cell mobility, as some SSB indices that were not part of the configured CSI-SSB-ResourceSet may become more relevant for example if they have higher received powers now. For instance, the network may configure the UE to report L3 measurement report which is sent to the CU. It may be worthwhile to note that, the L3 measurement configuration is generally controlled by RRC and is completely separate from CSI measurement configuration which is at least partly controlled by MAC. The L3 measurement report may include cell quality measurements (derived by the UE based on beam measurements) and L3 beam measurements (L3 filtered L1 beam measurements). Using this measurement report, the network can know if there are more relevant SSB indices and whether there is a need to update CSI-SSB-ResourceSet. As a result, the network may provide the UE with another L3 measurement configuration where the UE is not mandated to measure a specific set of SSB indices. However, as can be understood by the skilled person, continuous update of CSI-SSB-ResourceSet would cause high signaling overhead over the radio and network interfaces, including:
Overhead over the radio: The update of CSI-SSB-ResourceSet would generally require the transmission of for example an RRC Reconfiguration message from the network to the UE and a corresponding RRC Reconfiguration Complete from the UE to the network.
Overhead over the network interface: In order to update the CSI-SSB-ResourceSet, the CU would generally need to coordinate the new configuration with the serving/source and target DUs over the F1 interface.

In addition to signaling overhead, the UE may also risk a mobility failure (e.g., due to a missed cell change) if the update of CSI-SSB-ResourceIndex is not performed in time when the UE still has a good serving radio link.

Yet further, it may also be worthwhile to mention that, compared to some techniques (such as inter-cell beam management (ICBM)) where the UE would typically be configured with only one non-serving cell (or in other words, one target cell), in L1/2 inter-cell mobility the UE may be configured with multiple cells (e.g., up to 8 or even more prepared target cells) which makes the problem even more pronounced. That is to say, depending on various implementations, the CU may be able to be configured to fetch from various DUs configurations for up to 8 (potential) target cells and to send those configurations to the UE (for L1 measurements and subsequent switching/mobility).

Therefore, generally speaking, the present disclosure may be seen as to seek to propose techniques/mechanisms for configuring the network nodes (as well as the UE) for supporting the L1/2 mobility (or referred to as lower layer mobility, LLM), in order to address at least some or all of the above-illustrated issues.

In a broad aspect, according to some example embodiments, the present disclosure generally proposes that the network (the CU and/or the DU) may configure the UE to report the N (e.g., 1, 2, 4 or any other suitable number) strongest L1 beam measurements for a set of prepared target cells without referring to an explicit list of SSB (or CSI-RS) indices (SSB-RI or CRI) to measure. Herein, depending on various circumstances and/or requirements, in some possible implementations, it may be left for the UE implementation to determine and decide on the relevant SSB (or CSI-RS) to measure among those detected ones. To be more specific, according to some possible (but non-limiting) implementations, the UE may decide completely by itself on SSB indices that it shall measure and report.

The list of target cells that shall be measured by the UE (e.g., up to 8) may be fixed and correspond to the prepared cells for L1/2 centric mobility. This list of cells can be updated by the CU based on, e.g., L3 measurement report, e.g., to prepare a new target cell, replace or remove a target cell.

According to some other possible (but non-limiting) implementations, the number Q of SSB indices to measure and use for L1 beam measurement reporting may still be a number lower than 64 (or any other suitable maximum number of SSB indices configured by higher layers) and Q+M=64, where M generally refers to the number of SSB indices that are configured by the network in CSI-SSB-ResourceSet for the UE to measure as described above.

As an illustrative example for understanding, Q may be configured as 24. Then for the remaining M=64−24=40 measurements, the measurement configuration and reporting provided by the network as before could apply; while for the rest Q=24 measurements, the UE could decide what to measure and report, for example—depending on various implementations—also to capture non-configured SSBs which became strong in between. According to some further possible (but non-limiting) implementations, the UE may be configured to measure up to 64 SSB indices configured by the network; and in addition, another number Q of strongest L1 beam measurements (e.g., for indices of those not configured SSBs). Configured as proposed above, the UE may still conform with the maximum UE capability of measuring up to 64 SSB indices simultaneously as configured/required according to the standardization.

In reporting, generally speaking, the UE may include a suitable (cell-specific) identifier to enable the serving DU to distinguish between the L1 beam measurements of different cells, where the cell identifier may be determined/designed to be associated with each prepared cell (e.g., identified by the PCI, or any other suitable identifier/ID available within a gNB or globally within the whole network). This has the advantage that the UE may be able to send only 3 bits (or any other suitable number of bits, possibly depending on the total number of cells to be distinguished therefrom) for the cell identifier (e.g., for up to a maximum number of 8 prepared target cells) instead of the normal/typical much longer cell-wise or network-wise identifier (e.g., 10 bits for the PCI). Of course, depending on various implementations and/or requirements, any other suitable (existing or new) identifier (with a shorter length compared to a normal/typical cell identifier, such as the PCI) may be considered (or proposed), as long as it is generally possible to be used for the network nodes (e.g., the CU and the DU) as well as the UE to be able to distinguish between the L1 beam measurements of different cells.

In a broad sense, the present disclosure generally proposes three different possible example methods to coordinate the suitable (cell-specific) identifier (e.g., a cell index or similar such as PCI) among the UE, CU and (serving and target DUs), which will now be described in more detail with reference to the figures. It is to be noted that, identical or like reference numbers used in the figures of the present disclosure may, unless indicated otherwise, indicate identical or like elements. Similarly, identical or like messages (as well as the contents comprised therein) used in the figures of the present disclosure may, unless indicated otherwise, indicate identical or like messages (and the contents therein), such that repeated description thereof may be omitted for reasons of conciseness.

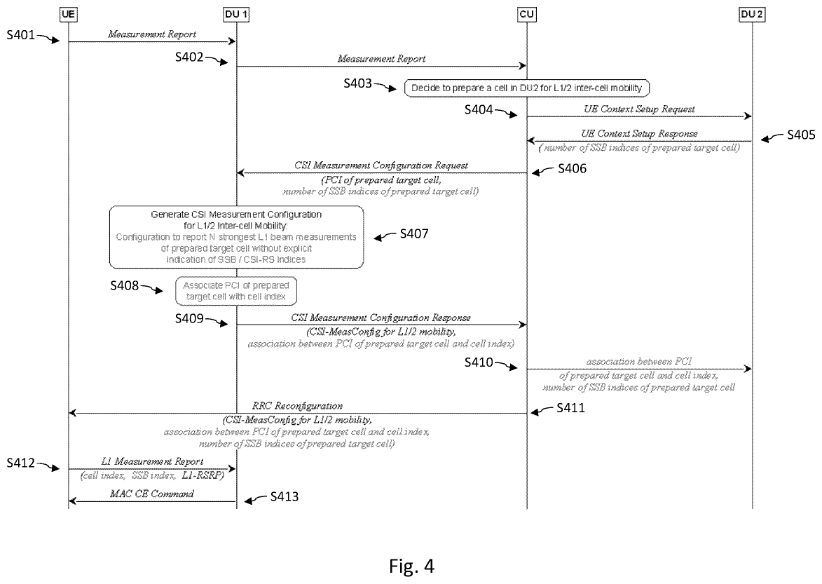

First of all, FIG. 4 schematically illustrates another example of a signaling/messaging flowchart according to some example embodiments of the present disclosure.

In general, in the example embodiment of FIG. 4, it may be understood that the (source) DU is configured to determine the cell identifier (here the cell index) for distinguishing the L1 measurements of the cells. Thus, it is also the DU that is responsible to associate the PCI(s) (or any other suitable cell identifier, for example available within a gNB or globally within the whole network) of the prepared target cell(s) with the cell index. Of course, in such case, the DU would also have to provide the determined association between the cell index and PCI to the CU which may in turn send it to the UE (and if necessary, also the other DU(s)).

More specifically, in steps S401 and S402, the UE may report a measurement to the source/serving DU (DU 1) which may then also propagate such measurement report to the CU (similar to steps S101 and S102 in FIG. 1).

Subsequently, based on the measurement report(s), the CU may identify and decide, in step S403, to prepare a (target) cell (or a set of potential target cells) in DU 2 (or, in some possible implementations, even in DU 1) for enabling L1/2 inter-cell mobility.

Similar to steps S103 and S104 or steps S105 and S106 of FIG. 1, the CU may then request the preparation of the candidate target cell controlled by DU 2 for example by sending a UE Context Setup Request message (or any other suitable message); and in return, receive the configuration in a corresponding UE Context Setup Response message (or any other suitable message) containing a message container from DU to CU.

In step S406, the CU may send the PCI of the prepared target cell (e.g., received from the DU, or obtained by the CU by using any other suitable means) to DU 1. This information may be sent from the CU to DU 1 in any suitable message (e.g., as part thereof), such as a CSI Measurement Configuration Request message as exemplified in step S406.

Upon receipt of such CSI Measurement Configuration Request from the CU, DU 1 may be configured to generate a CSI Measurement Configuration for supporting the L1/2 inter-cell mobility in step S407. Specifically, as illustrated above, DU 1 may generate the configuration for instructing/configuring/enabling the UE to report N strongest L1 beam measurements of the prepared target cell without explicit indication of the SSB/CSI-RS indices configured by higher layers.

In addition, in the present example embodiment, DU 1 would also, in step S408, determine an association between the PCI (received from the CU in step S406) and the cell index (which is designed in a suitable manner to enable the distinguishing for the measurements of different cells, as illustrated above). Depending on various implementations and/or requirements, such association may be determined by any suitable means. For instance, a (predetermined or preconfigured) mapping function/algorithm or lookup table (LUT) may be used to map the PCI (of 10 bits) to a suitable cell index (e.g., of 3 bits, which is generally determined based on the number of cells to distinguish). Of course, as can be understood and appreciated by the skilled person, any other suitable means may be used, as long as the measurements of the cells can be properly identified.

Once the association between the PCI(s) and cell index(es) has been created/generated, such association would be propagated to the CU as shown in step S409. In some possible implementations, in order to support dynamic switching for example between prepared target cells (or between the target cell and the original source/serving cell), this association information may also be further propagated to DU 2 (as well as other suitable DU(s), if deemed necessary) as exemplarily shown in step S410.

The CU would then generate an RRC Reconfiguration message (or the like) and send it to the UE in step S411 (similar to step S108 in FIG. 1). Similar as has been illustrated above, such configuration message may comprise CSI measurement related configurations suitable for supporting the L1/2 mobility functionality. Further, the association between the PCI and the cell index that has been generated by DU 1 may also be notified by the CU in this configuration message (or in any other suitable manner). It may also be worthwhile to note that, although not explicitly shown in the figure, as can be understood and appreciated by the skilled person, the configuration for the UE to report the N strongest L1 beam measurements of the prepared target cell without explicit indication of the SSB/CSI-RS indices configured by higher layers (in step S407) would also be propagated from DU 1 to the CU (e.g., as part of the CSI Measurement Configuration Response message or in any other suitable message); and in turn, be propagated from the CU to the UE (e.g., as part of the RRC Reconfiguration message or in any other suitable message).

The above process, in particular steps S403 to S409 may be repeated for a plurality of target cells (e.g., PCells and/or PSCells) that are prepared for L1/2 inter-cell mobility, thereby generating a list of associations between PCIs of the target cells and cell indexes, wherein one cell index is associated with one target cell. The configurations of all prepared target cells could be consolidated by the CU as one collective measurement configuration and sent in one RRC Reconfiguration message, or the CU could send a respective RRC Reconfiguration message containing a respective measurement configuration for a target cell whenever the CU prepares the target cell.

As a result, the UE may now start to report (e.g., periodically, aperiodically, etc.) the L1 beam measurement(s) as shown in step S412. This time, the UE may report, along with the L1-RSRP, at least the cell index (for the DU to identify the corresponding target cell) as well as the SSB index for identifying the corresponding beam. To be more specific, the UE may report in the CSI Report (containing the L1 beam measurements) the SSB index that is detected by the physical layer instead of the SSB-RI which generally refers to the running index (entry index) of the SSB that is configured in the CSI-SSB-ResourceSet configuration as illustrated above with reference to FIG. 3. This SSB index is needed since, in the proposed embodiment, the network does not indicate a specific list of SSB indices to measure, and as such the SSB-RI (which is used in conventional techniques) cannot be used.

Finally, similar to step S111 in FIG. 1, upon determining that there is a target candidate cell having a better radio link/beam measurement than that of the serving cell (e.g., based on the determination that the L1-RSRP of the target beam measurement is larger than the L1-RSRP of serving beam measurement, or any other suitable criteria), DU 1 may send a suitable MAC CE (or an L1 message) in step S413 to trigger the cell change/switch to the target candidate cell.

In some possible implementations, the CSI report may be further enhanced to possibly minimise the number of bits to be used for reporting the SSB index associated with the target cell index. For instance, as an illustrative (non-limiting) example, the CU may request from a DU (controlling a prepared target cell, such as DU 2 in the example of FIG. 4) to provide the number of RS indices (e.g., SSB indices) that are supported in the prepared target cell. This information, i.e., the number of SSB indices of the target cell, may be sent to the CU as part of the exemplary UE Context Step Response message as shown in step S405 (or in any other suitable manner). This information would also be propagated to the serving DU (i.e., DU 1 in the present example of FIG. 4), other suitable target DUs if necessary, as well as the UE (as exemplarily shown as part of steps S406, S410 and S411), which can derive, based on such information, the number of bits that could be allocated for reporting e.g., the SSB index of the respective prepared target cell (e.g., as shown in step S412).

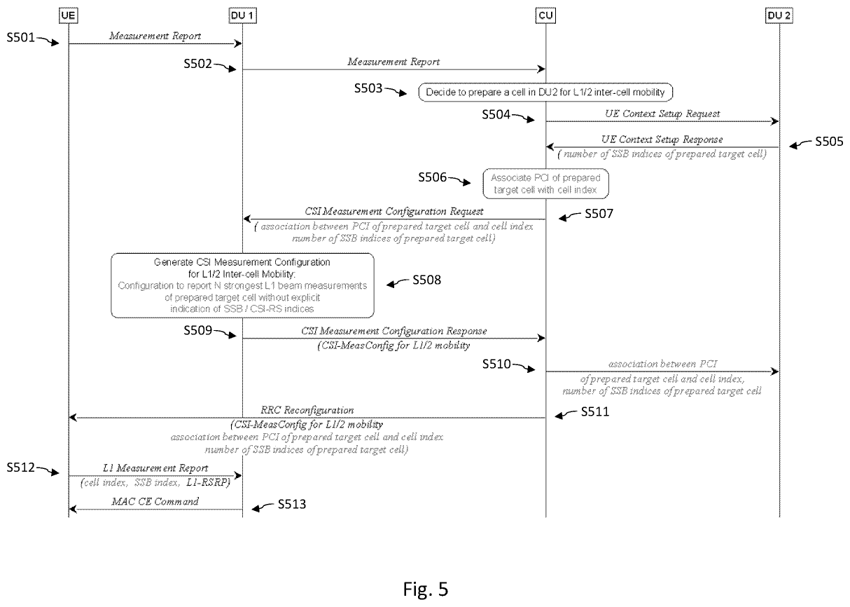

Secondly, FIG. 5 schematically illustrates another example of a signaling/messaging flowchart according to some other example embodiments of the present disclosure. As noted above, identical or like reference numbers or messages (as well as the contents comprised therein) used in the figures of the present disclosure may, unless indicated otherwise, indicate identical or like elements messages (and the respective contents therein), such that repeated description thereof may be omitted for reasons of conciseness.

Generally speaking, in the example embodiment of FIG. 4, it may be understood that the CU is now configured to determine the cell index for distinguishing the L1 measurements of the cells. Thus, it is also the CU that is responsible to associate the PCI(s) (or any other cell-wise or network-wise cell identifier as illustrated above) of the prepared target cell(s) with the respective cell index. Of course, in such case, the CU would have to provide the determined association between the cell index and PCI to the (source) DU and to the UE (and if necessary, also the other (target) DU(s)).

To be more specific, as can be seen from the figures, the example embodiment as shown in FIG. 5 is essentially the same as that in FIG. 4, except for that, instead of DU 1 being configured for associating the PCIs with the cell indices (step S408), it is now the CU which is configured to determine the association between the PCI with respective cell index for the prepared target cell (as exemplarily shown in step S506 of FIG. 5).

Again, the above process may be repeated for a plurality of target cells (e.g., PCells and/or PSCells) that are prepared for L1/2 inter-cell mobility, thereby generating a list of associations between PCIs of the target cells and cell indexes, wherein one cell index is associated with one target cell. The configurations of all prepared target cells could be consolidated by the CU as one collective measurement configuration and sent in one RRC Reconfiguration message, or the CU could send a respective RRC Reconfiguration message containing a respective measurement configuration for a target cell whenever the CU prepares the target cell.

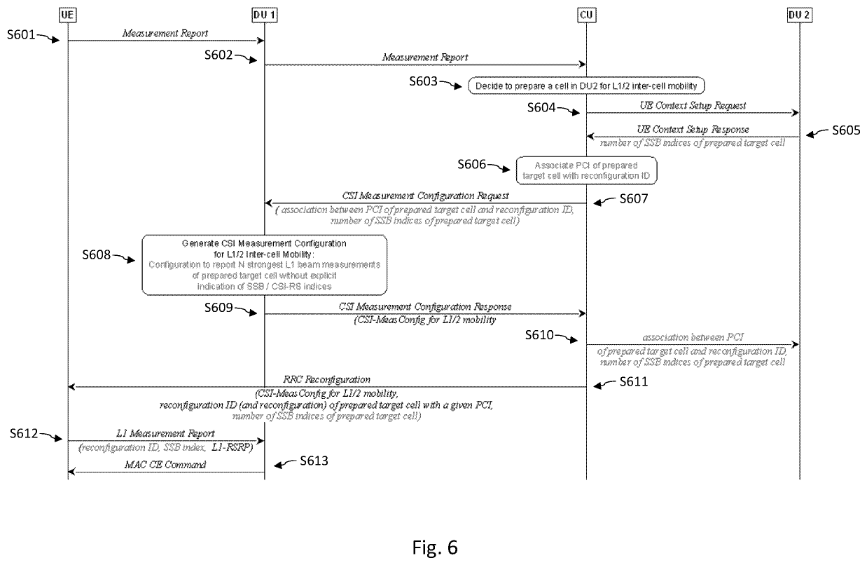

Finally, FIG. 6 schematically illustrates yet another example of a signaling/messaging flowchart according to some further example embodiments of the present disclosure. As noted above, identical or like reference numbers or messages (as well as the contents comprised therein) used in the figures of the present disclosure may, unless indicated otherwise, indicate identical or like elements messages (and the respective contents therein), such that repeated description thereof may be omitted for reasons of conciseness.

Generally speaking, in the example embodiment of FIG. 6, it may be understood that the CU is configured to determine the association for the PCI (or any other cell-wise or network-wise cell identifier as illustrated above) of the prepared target cell. However, in this example embodiment, instead of using the (newly introduced) cell index, a configuration identifier (ID) associated with the configuration of the prepared target cell (which, similar to the cell index, is generally shorter compared to other cell identifier such as the PCI) is (re-)used for identifying L1 beam measurements that are reported by the UE for the target cell. The configuration of the prepared target cell is used by the UE to perform a handover from the source cell to the target cell. Depending on various implementations and/or requirements, such configuration identifier may be pre-existing, preconfigured, predetermined, or configured to the UE as shown in step S611, or the like, as long as it is able for the network nodes (the CU and the DUs) as well as the UE to possibly use such configuration identifier to identify or distinguish the measurements of different cells.

As an illustrative example (but not to be understood as a limitation of any kind), in the example embodiment as shown in FIG. 6, the CU may associate, as shown in step S606, the PCI of the prepared target cell with a so-called “reconfiguration ID” that is itself associated with the configuration of the target cell that is used by the UE to perform a handover from the source cell to the target cell. Thus, depending on various implementations, such “reconfiguration ID” may have different names, as can be understood and appreciated by the skilled person. As the CU can prepare multiple target cells for L1/2 centric mobility (using steps S604 and S605), a different reconfiguration ID is associated with each target cell configuration. The UE applies one of the target cell configurations when it receives a MAC CE command from DU 1 as shown in step S613. The CU would also send, in step S611, the reconfiguration ID of the prepared target cell with a given PCI to the UE along with the corresponding target cell configuration. In this example, it may be generally assumed that the reconfiguration ID itself might be enough for the UE to possibly associate the measurement to the respective cell, such that an explicit and complete association between the PCI and the reconfiguration ID might not be needed. For instance, the UE can decode the target cell configuration that is associated with a reconfiguration ID to derive the PCI of the target cell. In this case, the PCI is not explicitly signaled by the CU in step S611 and it is acquired by the UE by decoding the target cell configuration. However, in some other examples, it may be possible that the CU may send the explicit and complete association between the PCI and the reconfiguration ID in the RRC Reconfiguration message. On the other hand, when reporting the measurement in step S612, the UE may now, instead of indicating the cell index (as is the case in the example embodiments of FIGS. 4 and 5), report the reconfiguration ID together with the L1-RSRP measurement (and possibly also the SSB index for identifying the beam). Such reconfiguration ID may then be used by DU 1 (or any other suitable DU(s) if necessary) to identify the corresponding cell with which this L1 measurement is associated (since such association, i.e., between the PCI and the reconfiguration ID has already been informed by the CU in step S607).

Similar as before, the above process may be repeated for a plurality of target cells (e.g., PCells and/or PSCells) that are prepared for L1/2 inter-cell mobility, thereby generating a list of associations between cell configurations of the target cells and cell identifier, wherein one cell identifier is associated with one target cell. The configurations of all prepared target cells could be consolidated by the CU as one collective measurement configuration and sent in one RRC Reconfiguration message, or the CU could send a respective RRC Reconfiguration message containing a respective measurement configuration for a target cell whenever the CU prepares the target cell.

For the sake of completeness, it is noted that, in any of the example embodiments as described above with reference to FIGS. 4 to 6, in case of a release or a replacement of a target cell, the UE may generally be configured to release/or replace the cell index corresponding to the target cell that is released or replaced.

It is also to be noted that, even though in the example embodiments of FIGS. 4 to 6 the association between the (longer) PCI (or any other cell-wise or network-wise cell identifier) and a suitable (shorter) identifier (either the cell index or the reconfiguration ID, or the like) may seem to be propagated between the network nodes and the UE at specific timing/sequence, this does not necessarily have to be always the case. Depending on various implementations and/or requirements, such association between the PCIs of the prepared cells and the cell index (or reconfiguration ID) can also be sent at a later (or even earlier) point of time, e.g., at the cell change triggering.

It is yet to be noted that, although it may appear that only examples of the cell index or the reconfiguration ID are described, as can be understood and appreciated by the skilled person, any other suitable identifier may be adopted as well, as long as that identifier is able to allow the network nodes as well as the UE to possibly identify and distinguish the measurements of the different cells.

To summarize the above, when configured as proposed above, the network generally does not need to maintain the proper configuration of the SSB indices for L1/2 inter-cell mobility anymore. As a result, mobility failures caused by possible misconfiguration of the SSB indices may be avoided, thereby saving the signalling overhead associated with RRC reconfiguration for configuring/updating the list of SSB indices and also reducing the signalling overhead associated with the reporting of PCI (10 bits) for each L1-RSRP.

According to another aspect of the present disclosure, the CU assigns a temporary, dynamic mapping table to report cell id+related measurements. The table includes a coding with a shorter length compared to normal PCI to identity the cells which have been measured and to reduce signalling traffic, e.g., in the following example procedure:

The UE sends to the CU L3 measurements of (strongest) detected cells. The CU selects a number (e.g. 8) cells to be further measured by the UE, e.g., the 8 strongest, and/or best available cells in view of load conditions, etc. The CU may report this to the DU for LLM. The 8 selected cells have each their own physical cell identification PCI number, e.g., PC1, PC2, . . . , PCI8. Each PCI typically has a length of 10 bits. This would require already 80 bits to be transmitted by the UE to identify the cells (+the related measurement results transmitted by the UE).

Assigning new cell ids, e.g., only for measurement purposes, results in less signalling traffic, e.g. for 8 cells to be measured only 3 bits are required to distinguish the 8 cells:
001-PCI1
010-PCI2
100-PCI3
. . .
111-PCI8

This list of cells can be updated by the CU based on, e.g., L3 measurement report, e.g., to prepare a new target cell, replace or remove a target cell. For example, PCI1 to PCI5 should still be measured, but if PCI6 to 8 needs to be replaced by PCI9 to 11, then a new updated assignment will be provided, e.g.:
001-PCI1
010-PCI2
100-PCI3
. . .
101-PCI9
110-PCI10
111-PCI11

Using only 3 bits (instead of 10) requires only 24 bits instead of 80 bits to be transmitted by the UE to identify the 8 cells to be measured (+the related measurement results transmitted by the UE) and thus reduces signalling significantly.

If more than 8 cells should be measured, e.g., up to 16, then 4 bits could be used for encoding.

If UE wants to report a non-configured/non-prepared cell it uses, e.g., normal PCI and aperiodic L1 report or L3 measurement report

According to another example procedure, the UE sends to CU L3 measurements of (strongest) detected cells. The CU selects a number (e.g., 8) to be further measured by UE, e.g. the 8 strongest, and/or best available cells in view of load conditions, etc. The CU configures the UE to report on the 8 cells in a (pre-) determined order, e.g., PCI1, PCI2, . . . , PCI8. The UE then sends measurement reports with measurements related to PCI1 first, then related to PCI2 second, etc. The DU (or CU) would then inherently know from the received report which measurement refers to which cell. In this case not even the 3 bit cell identifier would be needed. In this case, the UE needs to report always a pre-defined number of measurements for each prepared cell. Otherwise, the network may not know how to interpret the results.

In order to allow for a more flexible reporting for a varying number of measurements, the following variation of the procedure may be adopted.

If the UE reports measurements of, e.g., only 7 cells, then the non-reported cell could, e.g., be marked as “not measured” (e.g., by XXX), thus no mis-interpretation on the receiving side would occur. The (predefined) protocol of the report then may include, e.g., measure1 bits, measure2 bits, . . . . The reporting on actual measurements for cell1, cell2 (which is not reported), cell3, . . . may include:
01010100111, XXXXXXXXXXX, 11001100110, . . .

XXXXXXXXXXX=reserved bits used to indicate that no measurements are reported for cell2, e.g. could be a predefined sequence, e.g. 00000000000, 11111111111, 10101010101, . . . . Alternatively, if there are no actual measurements available, the previous measurements could be reported again.

Alternatively, an additional flag (1 bit) could also be used to indicate if actual measurements are reported or not.

According to another example procedure, the network associates a PCI of a prepared target cell with a cell identifier (as discussed above). The network configures the UE to report X number of L1 beam measurements for the prepared target cell whose PCI is associated with a cell identifier in a predefined sequence, e.g., X=2 two beam measurements for each cell starting from the cell with smallest cell identifier (or vice-versa from the cell with the largest cell identifier to smallest) or in any predefined sequence that is indicated by the network. The DU implicitly derives the association between the reported L1 beam measurements and the PCI using the pre-defined sequence for reporting beam measurements. In case the UE skips the measurements for one prepared cell, it can indicate this to the network using a flag or a predefined sequence as explained above.

Finally, it is nevertheless to be noted that, although in the above-illustrated example embodiments (with reference to the figures), the messages communicated/exchanged between the network components/elements may appear to have specific/explicit names, depending on various implementations (e.g., the underlining technologies), these messages may have different names and/or be communicated/exchanged in different forms/formats, as can be understood and appreciated by the skilled person.

According to some example embodiments, there are also provided corresponding methods suitable to be carried out by the apparatuses (network elements/components) as described above, such as the UE, the CU, the DU(s), etc.

It should also be noted that the apparatus (device) features described above correspond to respective method features that may however not be explicitly described, for reasons of conciseness. The disclosure of the present document is considered to extend also to such method features. In particular, the present disclosure is understood to relate to methods of operating the devices described above, and/or to providing and/or arranging respective elements of these devices.

Further, according to some further example embodiments, there is also provided a respective apparatus (e.g., implementing the UE, the CU, the DU, etc., as described above) that comprises at least one processing circuitry, and at least one memory for storing instructions to be executed by the processing circuitry, wherein the at least one memory and the instructions are configured to, with the at least one processing circuitry, cause the respective apparatus to at least perform the respective steps as described above.

Yet in some other example embodiments, there is provided a respective apparatus (e.g., implementing the UE, the CU, the DU, etc., as described above) that comprises respective means configured to at least perform the respective steps as described above.

It is to be noted that examples of embodiments of the disclosure are applicable to various different network configurations. In other words, the examples shown in the above described figures, which are used as a basis for the above discussed examples, are only illustrative and do not limit the present disclosure in any way. That is, additional further existing and proposed new functionalities available in a corresponding operating environment may be used in connection with examples of embodiments of the disclosure based on the principles defined.

It should also be noted that the disclosed example embodiments can be implemented in many ways using hardware and/or software configurations. For example, the disclosed embodiments may be implemented using dedicated hardware and/or hardware in association with software executable thereon. The components and/or elements in the figures are examples only and do not limit the scope of use or functionality of any hardware, software in combination with hardware, firmware, embedded logic component, or a combination of two or more such components implementing particular embodiments of the present disclosure.

It should further be noted that the description and drawings merely illustrate the principles of the present disclosure. Those skilled in the art will be able to implement various arrangements that, although not explicitly described or shown herein, embody the principles of the present disclosure and are included within its spirit and scope. Furthermore, all examples and embodiment outlined in the present disclosure are principally intended expressly to be only for explanatory purposes to help the reader in understanding the principles of the proposed method. Furthermore, all statements herein providing principles, aspects, and embodiments of the present disclosure, as well as specific examples thereof, are intended to encompass equivalents thereof.

1-44. (canceled)

45. A first network node that supports at least one of central unit control plane, CU-CP, functionality or a layer 3 protocol of a radio access network, comprising:
at least one processor; and
at least one memory storing instructions that, when executed by the at least one processor, cause the first network node at least to:
determine to prepare a target cell of a third network node for lower layer mobility, LLM, with a source cell of a second network node, wherein each of the second network node and the third network node supports at least one of the distributed unit, DU, functionality or a layer 2 protocol of the radio access network;
obtain an association between a cell identifier of the target cell and a first identifier; and
transmit a configuration message comprising information indicative of the association between the cell identifier of the target cell and the first identifier to a user equipment, UE, served by the source cell.

46. The first network node according to claim 45, wherein the first network node is further caused to:
transmit a message comprising information indicative of the association between the cell identifier of the target cell and the first identifier to the third network node.

47. The first network node according to claim 45, wherein the first network node is further caused to:
receive, from the third network node, information indicative of a number of synchronization signal block, SSB, indices configured in the target cell.

48. The first network node according to claim 47, wherein the first network node is further caused to:
transmit the information indicative of the number of SSB indices configured in the target cell to at least one of the second network node, the third network or the UE.

49. The first network node according to claim 45, wherein the first identifier is a cell index for distinguishing between beam measurements of different cells.

50. The first network node according to claim 45, wherein the obtaining of the association between the cell identifier of the target cell and the first identifier comprises:
transmitting a request message comprising information indicative of the cell identifier of the target cell to the second network node; and
receiving, from the second network node, a response message comprising information indicative of the association between the cell identifier of the target cell and the cell index.

51. The first network node according to claim 45, wherein the obtaining of the association between the cell identifier of the target cell and the first identifier comprises:
determining, by the first network node, the association between the cell identifier of the target cell and the cell index; and
wherein the first network node is further caused to:
transmit a request message comprising information indicative of the association between the cell identifier of the target cell and the cell index to the second network node.

52. The first network node according to claim 45, wherein the first identifier is a configuration identifier associated with and for identifying a configuration of the prepared target cell that is used by the UE to perform a handover from the source cell.

53. The first network node according to claim 52, wherein the obtaining of the association between the cell identifier of the target cell and the first identifier comprises:
determining, by the first network node, the association between the cell identifier of the target cell and the configuration identifier; and
wherein the first network node is further caused to:
transmit a request message comprising information indicative of the association between the cell identifier of the target cell and the configuration identifier to the second network node.

54. The first network node according to claim 45, wherein the configuration message further comprises information indicative of a measurement related configuration.

55. The first network node according to claim 54, wherein the measurement related configuration comprises information for configuring the UE to report N strongest beam measurements of the prepared target cell without referring to an SSB index, or a channel state information reference signal, CSI-RS, index included in the configuration message.

56. The first network node according to claim 54, wherein the measurement related configuration comprises information for configuring the UE to decide by itself on SSB indices that the UE measures and reports.

57. The first network node according to claim 45, wherein the cell identifier is a physical cell identifier, PCI.

58. The first network node according to claim 45, wherein the first identifier has a bit length shorter than that of the cell identifier.

59. A second network node that supports at least one of distributed unit, DU, functionality or a layer 2 protocol of a radio access network, comprising:
at least one processor; and
at least one memory storing instructions that, when executed by the at least one processor, cause the second network node at least to:
obtain an association between a cell identifier of a target cell of a third network node that supports at least one of the DU functionality or the layer 2 protocol of the radio access network, and a first identifier, wherein the target cell is prepared for lower layer mobility, LLM, with a source cell of the second network node by a first network node that supports at least one of central unit control plane, CU-CP, functionality or a layer 3 protocol of the radio access network; and
receive, from a user equipment, UE, served by the source cell, a message comprising information indicative of a measurement report related to at least one beam of the target cell, and the first identifier.

60. A user equipment, UE, supporting being served by a source cell of a second network node that supports at least one of distributed unit, DU, functionality or a layer 2 protocol of a radio access network, the UE comprising:
at least one processor; and
at least one memory storing instructions that, when executed by the at least one processor, cause the UE at least to:
obtain an association between a cell identifier of a target cell of a third network node that supports at least one of the DU functionality or the layer 2 protocol of the radio access network, and a first identifier; and
transmit a message comprising information indicative of a measurement report related to at least one beam of the target cell, and the first identifier towards the second network node.

61. The UE according to claim 60, wherein the first identifier is a cell index for distinguishing between beam measurements of different cells; and
wherein the obtaining of the association between the cell identifier of the target cell and the first identifier comprises:
receiving, from a first network node that supports at least one of central unit control plane, CU-CP, functionality or a layer 3 protocol of the radio access network, a configuration message comprising information indicative of the association between the cell identifier of the target cell and the cell index.

62. The UE according to claim 61, wherein the received configuration message is a RRC Reconfiguration message further comprising CSI measurement related configurations suitable for supporting L1/2 mobility functionality and a number of SSB indices configured in the target cell, and the transmitted message is a L1 measurement report comprising the cell index, an SSB index, and information on L1-RSRP.

63. The UE according to claim 60, wherein the first identifier is a configuration identifier associated with and for identifying a configuration of the target cell for handover by the UE; and wherein the obtaining of the association between the cell identifier of the target cell and the first identifier comprises:
receiving, from a first network node that supports at least one of central unit control plane, CU-CP, functionality or a layer 3 protocol of the radio access network, a configuration message comprising information indicative of the association between the cell identifier of the target cell and the configuration identifier.

64. The UE according to claim 63, wherein the received configuration message is a RRC Reconfiguration message further comprising CSI measurement related configurations suitable for supporting L1/2 mobility functionality and a number of SSB indices configured in the target cell, and the transmitted message is a L1 measurement report comprising the configuration identifier, an SSB index, and information on L1-RSRP.

65. The UE according to claim 61, wherein the configuration message further comprises information indicative of a measurement related configuration comprising information for configuring the UE, without referring to a synchronization signal block, SSB, index, or a channel state information reference signal, CSI-RS, index included in the configuration message, to report N strongest beam measurements of the target cell.

66. The UE according to claim 61, wherein the configuration message further comprises information indicative of a measurement related configuration comprising information for configuring the UE to decide by itself on synchronization signal block, SSB, indices that the UE measures and reports.

67. The UE according to claim 60, wherein the transmitting a message comprises transmitting a message comprising information indicative of a measurement report relating to the strongest beam measurements of the target cell.

68. The UE according to claim 61, wherein the configuration message further comprises information indicative of a number of SSB indices configured in the target cell.

69. The UE according to claim 60, wherein the message transmitted to the second network node further comprises information indicative of an index of an SSB detected by the UE for the measurement.

70. The UE according to claim 60, wherein the UE is further caused to:
receive, from the second network node, a message comprising information indicative of an instruction for the UE to switch from the source cell to the target cell.

71. The UE according to claim 60, wherein the cell identifier is a physical cell identifier, PCI.

72. The UE according to claim 60, wherein the first identifier has a bit length shorter than that of the cell identifier.
